(19) United States
(12) Patent Application Publication
(10) Pub. No.: US 2019/0095548 A1
(43) Pub. Date: Mar. 28, 2019

(54) DESIGN SYSTEM FOR AIDING THE DESIGN OF A KITCHEN REFURBISHMENT

(71) Applicant: NEXT-TECH SPRL, Liège (BE)

(72) Inventors: Pierre IOANNATOS, Liège (BE); Thomas IOANNATOS, Engis (BE)

(21) Appl. No.: 15/765,786

(22) PCT Filed: Oct. 6, 2016
(86) PCT No.: PCT/EP2016/073852

§ 371 Date: Apr. 4, 2018

(30) Foreign Application Priority Data
Oct. 6, 2015 (BE) 2015/5628

(51) Int. Cl. G06F 17/50; G06F 3/0481

(52) U.S. Cl. CPC G06F 17/5004; G06F 3/04845; G06F 3/04815

(57) ABSTRACT

The design system (1) of the invention comprises: a plurality of objects (10) for representing on one and the same reduced scale refurbishment elements of a kitchen (40); a means for determining position for determining the position of said objects (10); a means of conversion for converting an item of position information of said objects (10) into an item of position information of the refurbishment elements (50) in said kitchen (40); a means of determination for determining (106) a project (107) for refurbishment of said kitchen (40) on the basis of the position (104) of the refurbishment elements (50) in said kitchen (40) and of a technical constraint (105); and a means of output for providing (108) information (109)) on said refurbishment project (107). The system allows the automatic inclusion of technical constraints in a kitchen (40) refurbishment project (107).

### TECHNICAL FIELD

According to a first aspect, the invention relates to a design system enabling to facilitate the design of a kitchen refurbishment. According to a second aspect, the invention relates to a method for enabling to facilitate the design of a kitchen refurbishment.

### STATE OF THE ART

The design of the refurbishment of a kitchen is sometimes laborious. Indeed, different criteria must be considered. Of course, the available space and the size of various refurbishment elements (fridge, dishwasher, cupboard, sink, kitchen island, cooker are a few examples) must be integrated. It is also important to ensure the practical and technical side of the refurbishment. To evaluate the practical character of a kitchen, the question must be asked, in particular, of the interest in having such an element close to such another element. For example, is it practical to have the fridge rather than the kitchen island close to the cooker? Examples of technical aspects of a refurbishment which must be integrated are: the place for a water inlet, the place for a water outlet, the power and the position of a power supply. There are also aesthetic aspects to fulfil such that the kitchen meets the clients' tastes.

To design a space such as a kitchen, often a trial and error from plans method is followed. This manner of proceeding is not practical, especially when the elements of a fitted kitchen must be chosen. It would be more practical to be able to see, in concrete terms, a refurbishment project without it being necessary to have a good viewing capacity in the space from two-dimensional plans. Furthermore, this known method can lead to errors is certain technical constraints are not considered.

### SUMMARY OF THE INVENTION

According to a first aspect, one of the aims of the present invention is to provide a system to aid the design of a kitchen refurbishment. To this end, the inventors propose a design system for aiding the design of a kitchen refurbishment and comprising:
a plurality of objects to represent, under a reduced size, a plurality of elements for refurbishing said kitchen, said objects all being of one and the same reduced scale in relation to the refurbishment elements;
a support comprising a surface of which at least one portion is able to support said objects;
a means for determining position,

said objects and said means for determining position being configured such that the latter is able to determine a position for each one of the objects placed on said portion;
a means of converting an item of position information of the objects placed on said portion into an item of position information in said kitchen of the refurbishment elements represented by said objects;
a means for determining refurbishment to determine a project for refurbishing said kitchen on the basis of an item of position information of the refurbishment elements in said kitchen obtained by said conversion means and on the basis of at least one technical constraint of a kitchen refurbishment; and
a means of output to provide information on the refurbishment project of said kitchen determined by said refurbishment determination means.

In the design system of the invention, different objects can represent different furniture, for example. They are of a reduced size in relation to the refurbishment elements that they represent. Preferably, they have the same shape overall as the refurbishment elements that they represent. Thus, the objects are not necessarily an exact reduced form of a refurbishment element, even if they are of a reduced size in relation to the elements that they represent. An object can therefore be any object, for example, not representative of the refurbishment element that it represents. An object can therefore be a pin or a LEGO® type part, for example, which represents a sink or a fridge, for example. Objects can be called miniatures or scale representations of the refurbishment elements. The representation is not necessarily exact to close detail, but it is preferably sufficient such that a user can easily make the connection between an object and a kitchen refurbishment element. Being of reduced sizes, objects can be handled easily by a person wanting to design an interior. These are three-dimensional objects which enable a user to get a good idea of the refurbishment elements that they represent, for example, through the intermediary of viewing means. In particular, a person can best see the volume of a refurbishment element from such an object representing it than from a plan. Furthermore, preferably having defined a portion of the surface of the support which corresponds to the kitchen to be refurbished, there can then be different objects which are wanted for the refurbishment. Creating a refurbishment project of a kitchen is therefore particularly quick, thanks to the positioning of the objects in the system according to the invention. It is particularly a lot quicker than it would be with conventional software used with a mouse and a screen.

The means for determining position enables to know the position of different objects on the surface of the support of which at least one portion can be a reduced, two-dimensional replica of the kitchen to be refurbished. In the framework of the present document, the position of an object or of an element can include the orientation thereof. The conversion means enable to obtain, in the kitchen to be refurbished, a position of a refurbishment element corresponding to an object placed on the surface of the support. The refurbishment determination means enable the system to automatically determine a refurbishment project. To do this, it uses the positions of the refurbishment elements in the kitchen and one or more technical constraint(s). Introducing technical constraints enables, in particular, to avoid errors in the refurbishment. Most of the time, a user who arranges objects on the system does not realise that such constraints are integrated. The means of output enable to provide information on the refurbishment project which includes the positions of the refurbishment elements in the kitchen and the technical constraints. Providing information about the refurbishment project is done, preferably by at least one of the following means: a display in real time of a view of the refurbished kitchen (for example, three-dimensional), a display in real time of a list of refurbishment elements and of additional refurbishment components, a display in real time of a plan of the kitchen comprising the refurbishment elements and the additional refurbishment components, an export of the information (for example, in the form of files) comprising such a view and/or such a list and/or such a plan, and a print-off of such a view and/or such a list and/or such a plan.

In other words, it is possible to have kitchen refurbishment information, that can be utilised, for example, by an IT system or by a control system, from the position of objects present on the surface of the support and from technical constraints. The display of the refurbishment is a lot more practical than having to imagine what a kitchen refurbishment represents from plans. The design system of the invention therefore enables to aid with the design of a kitchen refurbishment. The design system of the invention is particularly simple to use and intuitive.

Furthermore, the refurbished kitchen corresponding to the refurbishment plan is achievable and functional, as the refurbishment plan considers the technical constraints. The user, although ignorant of the specificities specific to the kitchen refurbishment, will not commit certain errors in this refurbishment, as the system of the invention forbids, corrects or proposes alternatives for the actions of the user which would lead to errors. The specificities specific to the kitchen refurbishment are, for example: the positioning of additional refurbishment components (side panels, backrests, worktops, filler) according to the technical constraints.

The design system of the invention has other advantages. The export of a file comprising a list of refurbishment elements and additional refurbishment components, or the print-off of such a list, enables an order to be placed for the refurbishment elements and components. For example, a list of these elements can be printed on a purchase order or this list can be sent to one or more suppliers of refurbishment elements located somewhere else. Such a way of proceeding is particularly effective and quick. By displaying the refurbishment of the interior from the results provided by the conversion means, it is possible to provide a person (a customer, for example) with an item of information that is particularly pleasant to see. The system of the invention therefore provides a commercial advantage. The design system of the invention enables to provide aid with achieving a kitchen refurbishment. This aid can be aesthetic or technical, for example (technical aid for preventing errors, for example). This aid can be automatic or by assisting a user during the design of the kitchen. It is, for example, possible to image that from the information processed by the design system of the invention, other tasks or actions can be achieved, like for example: advising a user, identifying, communicating and correcting possible errors (non-exhaustive list) and possibly proposing alternative solutions. Furthermore, the print-off of a plan comprising the refurbishment elements and the additional refurbishment components enables a fitter to directly fit the correct elements and components in the correct places, particularly in view of technical outlets and inlets.

From the data from the conversion means, it is possible to project a two-dimensional or three-dimensional image, according to the display means which are used.

Example of display elements are: furniture, door, stairs, plant, fridge, dishwasher, cooker, sink, chair, table, kitchen island, kitchen furniture, electrical appliance element. Other examples, however, are possible.

Objects can represent the same refurbishment elements. Preferably, they represent different refurbishment elements. Objects are at a reduced scale in relation to the support whereon they are arranged.

Preferably, the surface portion of the support for supporting the objects is mainly flat. Preferably, the surface of the support is mainly flat.

The data from the conversion means or from the determination means can also be processed by the support (when said support is a smart screen, for example) or sent remotely, for example, to another screen. Such another screen can be in the same place or in a different place from the design system of the invention.

A refurbishment project can also be called “refurbishment”. It comprises a set of data on the positions, types, shapes, sizes and other characteristics of the kitchen as a space and the items which are planned to be arranged in the kitchen. These items comprise refurbishment elements, elements contained in these refurbishment elements, and additional refurbishment components determined by the system.

In the framework of the present document, the front face of a refurbishment element is normally the vertical face provided to be seen by the user of the kitchen. It is the face which comprises the door, the handle, the possible control buttons. The rear face is opposite the front face and is often close to a wall. The side faces are the two other vertical faces, which are generally provided to be situated against a side face of another refurbishment element. In the framework of the present document, a line of refurbishment elements is a continuation mainly in a straight line of refurbishment elements, adjacent through their side faces.

A technical constraint can, for example, relate to the dimensions of the kitchen, the windows, doors, bay windows and other obstacles (chimney, low wall, etc.) present in the kitchen, a gap between a wall and the rear of a refurbishment element, an opening of a door or of a drawer, an alignment between several refurbishment elements, a size of a refurbishment element, a distance between several refurbishment elements, a size of an additional refurbishment component, a shape of the refurbishment (straight, L-shaped or U-shaped refurbishment), a worktop provided to cover the refurbishment elements, a constraint connected to the weight of a worktop can support, a technical inlet such as a hot water inlet, cold water inlet, water outlet, 32A electricity inlet, 16A electricity inlet, gas inlet, extractor hood, a safety constraint in order to prevent a user from having access to certain elements. Preferably, a technical constraint is a condition to verify and the refurbishment project is modified, or not, according to whether the result of this verification is positive or negative.

Preferably, the design system of the invention comprises an identification module, objects and said identification module being configured such that the latter is able to identify the objects present on said portion of said surface of said support. The design system of the invention is thus even more useful for the refurbishment of a kitchen as it enables to identify an object present on at least one portion of the surface of the support. Knowing the type of object present, it is possible to deduce the corresponding refurbishment element. This preferred embodiment is particularly useful when it is wanted to refurbish a kitchen with different refurbishment elements.

Different identification technologies can be used to identify an object present on the surface of the support. According to a possible implementation, at least one (preferably, each) object of said plurality of objects comprises, on an external surface, a visual code able to be scanned, and said identification module comprises a reading means for scanning said visual code. Examples of visual codes are: barcode, QR code. Other examples, however, are possible. Preferably, the support comprises the identification module.

Furthermore, preferably, the identification module is able to make each one of the identified objects correspond with a refurbishment element. For example, the design system can comprise a database that corresponds the visual codes present under the objects with the refurbishment elements. The design system according to the invention is, preferably, able to determine, on the basis of the refurbishment element obtained by corresponding with an object, the technical characteristics specific to said refurbishment element and to providing them to said refurbishment determination means such that they are included in the kitchen refurbishment project. These technical characteristics can thus be included as technical constraints during the determination of the refurbishment project. These technical characteristics can, for example, relate to sizes of the refurbishment element, the type of refurbishment element (dishwasher, furniture, sink, floor unit, wall unit, etc.), and the possible configurations of the refurbishment element. These technical characteristics can form the technical constraints included by determining the refurbishment project.

According to an embodiment of the invention, at least one refurbishment element has a technical characteristic indicating a position of a connection for a water inlet and/or an electricity inlet and information about the kitchen refurbishment project comprises an indication of position of a connection for a water inlet and/or an electricity inlet. For example, each refurbishment element which requires a water inlet, electricity and/or gas inlet, and/or a water or steam outlet connection, can comprise at least one of the following technical characteristics: connection type (hot water inlet, cold water inlet, water outlet, 32A electricity inlet, 16A electricity inlet, gas inlet, extractor hood), and position in relation to the refurbishment element (height at the axis, depth at the axis in relation to the rear face, width at the axis). Since determining the refurbishment project includes these technical characteristics, a technical plan provided by the system according to the invention can consequently include all the necessary information for the corresponding positioning of the inlets and outlets in the kitchen.

Preferably, the refurbishment determination means are able to involve at least one additional refurbishment component in said project for refurbishing said kitchen, the information about the project for refurbishing said kitchen comprising an item of information on said at least one additional refurbishment component. There can be one or more additional refurbishment components, of the same type or of different types. In the framework of the present document, an additional refurbishment component is any item of the kitchen refurbishment which is not represented by an object on the support. It can be, for example, a side panel, a backrest, a worktop, a filler or a hood. Preferably, determining at least one additional refurbishment component includes at least one technical constraint.

According to a possible embodiment of the invention, said refurbishment determination means are able to involve at least one additional refurbishment component in said project for refurbishing said kitchen, on the basis of said at least one technical constraints.

Preferably, said at least one technical constraint is a technical constraint determined from a difference between a length associated with one or more refurbishment elements and a distance between two walls of the kitchen.

Preferably, the at least one additional refurbishment component comprises a filler to fill the space between the refurbishment elements and a wall of the kitchen. A filler, also called a filling item, is a refurbishment element generally arranged between a refurbishment element which is at the end of a line of refurbishment elements and a wall. It is positioned in the continuity of the front faces of the refurbishment elements of the line. A filler is a first type of additional refurbishment component. It enables, in particular, to avoid positioning the side face of the refurbishment element against a wall. Indeed, positioning a side face against a wall would lead to a risk of the door of the furniture bumping against the wall and would pose a problem in the event where the wall would not be straight.

Preferably, the at least one additional refurbishment component comprises a side panel to cover an end of a line of refurbishment elements and/or the at least one additional refurbishment component comprises a backrest intended to cover the rear faces of the refurbishment elements. A side panel is a refurbishment element arranged on a side face, visible from a refurbishment element. It can have a technical function and/or an aesthetic function. The technical function thereof can be, for example, to protect the technical fittings to avoid children touching them or to support a worktop. Preferably, if the side panel has no technical function, the system gives the choice to the user to position the side panel or not. A side panel is a second type of additional refurbishment component. According to an embodiment of the invention, determining a side panel is based on a technical constraint related to the distance between the side face whereon the side panel would come and a wall facing said side face. For example, if this distance is beyond a certain threshold, a filler is added to the refurbishment project during the determination of at least one additional refurbishment component, and if this distance is at least equal to this threshold, a side panel is added to the refurbishment project during the determination of at least one additional refurbishment component. A backrest is a refurbishment element arranged on a rear face visible from a refurbishment element. It can have a technical function and/or an aesthetic function, like the side panel. A backrest is a third type of additional refurbishment component. According to an embodiment of the invention, determining a backrest is based on a technical constraint related to the distance between the rear face whereon the backrest would come and a wall facing said rear face. For example, if this distance is at least equal to a certain threshold, a backrest is added to the refurbishment project during the determination of at least one additional refurbishment component.

Preferably, the at least one additional refurbishment component comprises a worktop. The worktop rests on at least one part of the refurbishment elements. A first technical constraint is that, most of the time, a worktop is necessary to cover certain refurbishment elements. A second technical constraint for the worktop can be that it overruns sufficiently to cover the handles of the refurbishment elements under it, in order to avoid a user hanging onto it. Another technical constraint can be connected to the sizes of the standard panels which form the worktop. According to an embodiment of the invention, the refurbishment determination means determine the position of these panels such that a minimum number of panels is used.

According to an embodiment of the invention, the design system is arranged to enable a user to add an extension to the worktop in a limitative context, provided by a technical constraint relating to a weight that the extension of the worktop can support and/or relating to a panel size forming the worktop. In particular, the display means of the design system can display icons indicating where the worktop can be extended. The icons are preferably displayed on the side of the objects in places where an extension is possible in view of the technical constraint(s). The limitative context is such that these icons only appear where the worktop can be extended, while adhering to the technical constraint(s). The technical constraint relating to a weight that the extension of the worktop can support is connected to the fact that the extension of the worktop is cantilevered in relation to the refurbishment elements. Indeed, if a heavy object is arranged on the end of the extension, a force torque proportional to the distance is exerted over the part of the worktop attached to the refurbishment elements. It is therefore preferable to forbid extensions that are too large, or to force the user to position poles or a side panel under the extension if they want a large extension. The technical constraint relating to a panel size forming the worktop is connected to the fact that these panels have a standard size.

Preferably, determining a project for refurbishing said kitchen comprises a verification of at least one technical constraint and, in the event where said at least one verified technical constraint is not adhered to, a display of a message or an automatic correction of the refurbishment project (07) such that this adheres to said at least one verified technical constraint. The refurbishment determination means are able to carry out said verification, said display and said automatic correction. Several technical constraints can be verified one after the other, for example, by following a decision-making diagram. For example, if the objects are incorrectly aligned to each other or incorrectly aligned in relation to a wall of the refurbishment project, the design system can align them to each other or align them in relation to the wall. For example, if a wall of the kitchen is displayed on the support, the objects can be positioned against a wall by the user. The system is thus provided to offset the refurbishment element from the wall in the refurbishment project, as in a kitchen, it is preferred that the refurbishment elements are not against the walls. For example, if the user puts a piece of furniture such that the door thereof does not open, the system will let them know through a message. Likewise, the same occurs if they position a piece of furniture at an angle at the centre of a line of refurbishment elements.

Preferably, the means for determining position comprises a touchscreen at the level of the surface of the support. This enables to have a design system of a kitchen that is particularly easy to design and to use. Furthermore, such a preferred embodiment gives an innovative, modern, “high-tech” aspect to the design system of the invention. This preferred technical characteristic of the design system of the invention enables to bring a modern character into the field of kitchen refurbishment. Compared with an IT system enabling to design a kitchen refurbishment from a computer, the design system of the invention is more intuitive and simpler to use, in particular, through the presence of different objects, representing different refurbishment elements under a reduced size. These objects can be handled by a person before positioning them on the surface of the support.

Different technologies for determining position can be used to determine the position of an object on the surface of the support. According to a possible implementation, each object comprises a transmitting antenna, and the means for determining position comprise at least one receiving antenna able to capture an electromagnetic wave transmitted by the transmitting antenna of an object to determine the position thereof on said surface of the support. Preferably, such receiving antenna(s) is/are situated in the support. According to another possible implementation, at least one portion of each object comprises an electrical conducting material, and the means for determining position comprises at least one inductive sensor. In this case, the at least one inductive sensor is preferably situated at the level of the support. Other examples of technologies for determining position are: camera system, infrared method, mechanical or electronic system. In the first case, it is possible to provide a camera system (for example, of the infrared type), positioned in the support for example, which is able to scan objects which have been arranged on at least one portion of the surface of the support. Using a printed code positioned on an object or on the part of the shape of an object, the camera system (or the infrared type or otherwise) can detect and preferably identify an object positioned on at least one portion of the surface of the support. Another technology for determining position uses a set of cameras positioned above the support and which enable to detect objects positioned on at least one portion of the surface of the support. Preferably, this set of cameras is further able to identify such objects. Technologies of the mechanical or electronic type use direct connections between the support and objects positioned on at least one portion of the surface of the support to determine the position of an object. Preferably, these technologies further enable to identify an object positioned on at least one portion of the surface of the support. A technology of the mechanical type can, for example, differentiate different objects according to their weight. In this case, an identification module preferably comprises one or more pressure sensors integrated in the support.

Preferably, the design system of the invention further comprises display means for displaying an item of refurbishment information from an item of information from said conversion means and/or said identification module. Different display means can be used. An example of display means is a screen. Preferably, this screen is integrated in at least one portion of the surface of the support. In this case, the design system of the invention is particularly practical to use. A user can arrange objects on the surface of the support and directly see the corresponding refurbishment by inspecting the portion of the surface of the support where the refurbishment information is displayed. Preferably, the display also occurs on the portion of the surface supporting the objects. For example, walls, doors, windows, bay windows and other obstacles (for example, a chimney, a low wall, etc.) of the kitchen are displayed there, such that the objects are positioned by the user in relation to the walls, doors, windows, bay windows and other obstacles. The display can also comprise the display of icons next to the objects. These icons can be used to modify the characteristics, particularly technical, of the refurbishment elements corresponding to the objects. For example, an icon for an item of storage furniture enables to configure the interior of this storage furniture, to choose the model, to choose the colour thereof.

Preferably, the design system of the invention comprises an interfacing means for aiding the design of the kitchen refurbishment. Preferably, this interfacing means is integrated at the level of at least one portion of the surface of the support. Such an interfacing portion can comprise, for example, a touchscreen. The interfacing is thus particularly easy. This interfacing means can be used for different functions. It can, for example, be used to involve or modify geometric technical characteristics of the kitchen to be refurbished, like for example: the shape of the kitchen, the size thereof. It is also possible to provide an interfacing means which enables to add one or more windows, one or more doors, one or more bay windows and one or more obstacles in the kitchen to be refurbished. The interfacing means could also be able to provide different information about the refurbishment elements represented by the objects, like for example the available colours, the available materials, the size of these refurbishment elements, their weight, their availability in stock, their price. Other characteristics, in particular, technical, the refurbishment elements could be obtained and/or seen through the intermediary of such an interfacing means. The interfacing means could also recommend a list of refurbishment elements to use for a given type of space to be refurbished, for example, a list of furniture and electrical appliances for a kitchen.

Rather than integrating this interfacing function in a portion of the surface of the support, the design system of the invention could comprise an interfacing module outside of this surface. An example of external interfacing means is a screen with a mouse and/or a computer keyboard.

Preferably, the design system of the invention comprises a memory to record the kitchen refurbishment project. This memory can be integrated in the support or be external to the latter. Thanks to this preferred embodiment, it is therefore possible to create and record different refurbishment projects. It is also possible to reopen a refurbishment project that has been worked on previously, and possible to modify it and/or print off an order list comprising retained refurbishment elements. Furthermore, the memory can contain a database enabling to correspond objects with refurbishment elements. The memory can be remote from the support, for example, it can be on an IT server.

According to an embodiment, the refurbishment determination means are able to modify the position and/or the orientation of the refurbishment elements provided by the conversion means in order to satisfy the at least one technical constraint. This enables correction of the errors made by a user during the positioning of the objects. For example, the system is able to determine an angle between a refurbishment element represented by an object and a wall of the kitchen and to align said refurbishment element with said wall if this angle is in a second determined interval. The technical constraint here is a constraint of aligning the refurbishment elements. Another example is to offset or stick to a wall, certain refurbishment elements whereas the corresponding objects are positioned too close or too far from the wall.

According to an embodiment, the system is able to determine an angle between a refurbishment element represented by an object and a wall of the kitchen and to display a message if this angle is in a first determined interval. This indicates to a user that the object positioned is so incorrectly oriented that the system is not certain of the orientation desired.

According to an embodiment, the means of output comprise one or more devices among the following: a printer, display means, and an internet connection.

According to an embodiment, the means for determining position and the conversion means form part of one same computer.

According to a second aspect, the inventors propose a method for aiding the design of a kitchen refurbishment and comprising the following steps and preferably carried out in this order:
providing a plurality of objects representing, under a reduced size, a plurality of elements for refurbishing said kitchen, said objects all being of one and the same reduced scale in relation to the refurbishment elements;
providing a support comprising a surface of which at least one portion is able to support said objects;
arranging one or more objects of said plurality of objects on said portion;
determining a position for each one of the objects placed on said portion;
converting an item of position information of the objects placed on said portion into an item of position information in said kitchen of the refurbishment elements represented by said objects;
determining a project for refurbishing said kitchen on the basis of position information of the refurbishment elements in said kitchen obtained in the preceding step and on the basis of at least one technical constraint of a kitchen refurbishment; and
providing information about the project for refurbishing said kitchen determined in the preceding step.

The advantages mentioned for the design system applied to the method, mutatis mutandis. In particular, the method of the invention is an aid with the design of a kitchen refurbishment. The method of the invention is also particularly practical and intuitive to design the kitchen refurbishment. The method of the invention enables errors to be avoided and move particularly quickly during the design of a refurbishment.

The different preferred embodiments of the design system of the invention are applied to the method, mutatis mutandis. In particular, the step of determining a project for refurbishing said kitchen can comprise a determination of at least one additional refurbishment component, preferably on the basis of the at least one technical constraint, and the project for refurbishing said kitchen can comprise the at least one additional refurbishment component. In this case, information about the project for refurbishing said kitchen comprises an item of information about the at least one additional refurbishment component. Furthermore, the step of determining a project for refurbishing said kitchen can also comprise a verification of at least one technical constraint and, in the event where the at least one verified technical constraint is not adhered to, a display of a message or an automatic correction of the refurbishment project such that this adheres to the at least one verified technical constraint.

According to an embodiment, the method of the invention further comprises, after the step of arranging the objects and before the step of determining a kitchen refurbishment project, a step of identifying the objects present on said portion and corresponding each one of them with a refurbishment element and a step of determining, on the basis of the refurbishment elements thus obtained, the technical characteristics specific to said refurbishment element, said technical characteristics specific to said refurbishment element being used during the determination of the kitchen refurbishment project. The technical characteristics can, for example, be considered as technical constraints during the determination of the kitchen refurbishment project. This enables the system to know the technical characteristics specific to the refurbishment elements represented by the objects.

Furthermore, the method of the invention can comprise a step of identifying one or more object(s) placed on at least one portion of the surface of the support. The method of the invention can also comprise a step of providing an item of refurbishment information about the kitchen to be refurbished from a result of the step of converting a position of an object into a position of a corresponding refurbishment element and/or from a result of the step of identifying an object.

According to an embodiment, the method of the invention comprises a step of displaying an information request to a user, a step of receiving an item of user information and a consideration of the user information during the step of determining a project for refurbishing said kitchen. The display of the information request can, for example, take the form of a message or an icon. The user can thus enter an item of user information, for example, relating to drawers or shelves inside a refurbishment element or an extension of a worktop, or the positioning of a side panel. This information is received by the system and included for the refurbishment project, for example, as a technical constraint.

According to an embodiment, the method of the invention comprises a display, on the portion of said surface of said support provided such that the objects are arranged there, a diagram representing the walls of the kitchen. For example, the user can the walls described, potentially also the windows, doors, bay windows and other obstacles (chimney, low wall, etc.), of their kitchen via an interfacing means and a top-down view representing these walls can appear on the surface portion. The user can thus position objects in relation to the walls as they so wish.

According to an embodiment, a positioning of an object outside of a surface between the walls of the kitchen generates a display of a message. For example, an error message can be displayed by the display means.

According to an embodiment, the step of determining a project for refurbishing said kitchen comprises of determining a distance between two refurbishment elements, and if this distance is below a certain threshold, and of aligning to each other of said two refurbishment elements.

According to an embodiment, the determination of the refurbishment project uses a decision-making diagram to include the position information of the refurbishment elements and the technical constraint(s).

According to an embodiment, the kitchen refurbishment project comprises a plan indicating the position in the kitchen of the refurbishment elements and, if the project comprises them, the position in the kitchen of the additional refurbishment components.

According to an embodiment, the kitchen refurbishment project comprises a list of refurbishment elements and, if the project comprises them, the additional refurbishment components.

According to an embodiment, said information about the refurbishment project comprises a plan indicating the position in the kitchen of the refurbishment elements and, of the project comprises them, the position in the kitchen of the additional refurbishment components.

According to an embodiment, said information about the refurbishment comprises a list of refurbishment elements and, if the project comprises them, the additional refurbishment components.

According to an embodiment, said list comprises an item of information about a price of at least one refurbishment element.

According to an embodiment, said information about the refurbishment project comprises a three-dimensional image of the kitchen comprising the refurbishment elements and, if the project comprises them, the additional refurbishment components.

### BRIEF DESCRIPTION OF THE FIGURES

These aspects, as well as other aspects of the invention will be clarified in the detailed description of specific embodiments of the invention, reference being made to the drawings of the figures wherein:

FIG. 1 shows a top view of the support of a possible embodiment of the design system of the invention;

FIG. 2 shows a top view of the support of another possible embodiment of the design system of the invention;

FIG. 3 shows a perspective view of the support corresponding to the same embodiment of the design system of the invention as that described in the preceding figure;

FIG. 4 shows possible examples of objects;

FIG. 5 shows an external face of objects comprising a visual code;

FIG. 6 shows a top view of a possible embodiment of the design system according to the invention;

FIG. 7 shows a perspective view of the same possible embodiment of the design system according to the invention;

FIG. 8 shows a perspective view of a user in the process of using the design system of the invention, while imagining their future kitchen;

FIG. 9 is a decision-making diagram illustrating a method for aiding the design of a kitchen refurbishment according to an embodiment of the invention;

FIG. 10 is a front view of a line of refurbishment elements between two walls; and

FIG. 11 shows a perspective view of a kitchen island.

The drawings of the figures are not to scale. Generally, similar elements are indicated by similar references in the figures. The presence of reference numbers in the drawings cannot be considered as limitative, including when these numbers are indicated in the claims.

### DETAILED DESCRIPTION OF CERTAIN EMBODIMENTS OF THE INVENTION

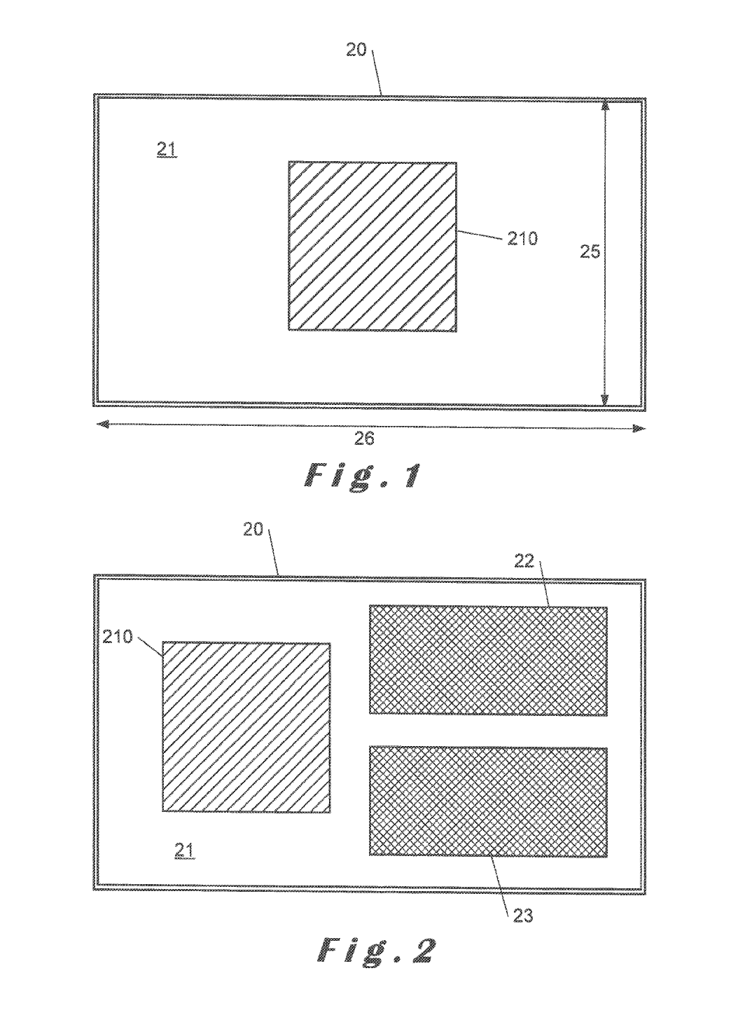

The design system 1 of the invention comprises different elements. FIG. 1 shows a first element. This is a support 20 comprising a surface 21 whereon one or more objects 10 can be arranged. These objects 10 represent, under a reduced size, the refurbishment elements. FIG. 4 shows four objects 10 as an example. These objects 10 could have other shapes than those shown in FIG. 4. The objects 10 can be of a different or identical size and/or shape.

A work area 210 of the surface 21 of the support 20 preferably represents a miniature replica of a view of the kitchen to be refurbished. For example, this work area 210 can represent a reduced size of a top view of the kitchen to be refurbished. This work area 210 could also represent a vertical section of the kitchen to be refurbished, for example, a wall of an item whereon different refurbishment elements such as furniture is wanting to be arranged. In FIG. 1, the work area 210 does not cover the whole surface of the support 20 which is visible along this section. This is a non-limitative preferred alternative. It could indeed be considered to provide a work area 210 extending over the entirety of the surface 21 of the support 20 which is visible in FIG. 1. The work area 210 enables to support one or more objects 10.

Different sizes of the support 20 are possible. By taking a top view such as the one shown in FIG. 1 and if the support 20 has the shape of a rectangle according to this view, the width 25 thereof is preferably between 50 cm and 2 m, whereas the length 26 thereof is preferably between 75 cm and 3 m. The thickness of the support 20 along a direction perpendicular to the plan in FIG. 1 preferably varies between 1 cm and 50 cm. Other thicknesses, however, are possible. Preferably, the support 20 is itself arranged on a base enabling a person, standing or seated, to easily arrange the objects on the support 20 and in particular on the work area 210 and to see said work area 210 from above. Thus, if the user is seated, the support 20 will preferably be positioned at a height of between 70 cm and 1 m in relation to the ground. If it is provided to use the design system 1 standing up, the support 20 will preferably be positioned at a height of between 1 m and 1.5 m.

The design system 1 of the invention further comprises a means for determining position. The objects 10 and this means for determining position are configured such that the latter is able to determine a position of an object 10 positioned on the work area 210. The means for determining position can be able to determine the positions X, Y of an object 10 as well as the orientation thereof.

Different types of means for determining position can be used. Preferably, the means for determining position comprises a touchscreen at the level of at least one portion of the surface 21 of the support 20. Preferably, such a touchscreen is coupled with an IT module enabling to give a position X, Y and an orientation of an object 10 positioned on the work area 210 of the surface 21 of the support 20. Other examples, however, are possible. It could be, for example, considered that each object 10 comprises a transmitting antenna and that the support 20 comprises one or more receiving antennas to capture an electromagnetic wave transmitted by a transmitting antenna of an object 10. From analysing the signal received, it is thus possible to determine the position of an object 10. According to another example, each object 10 comprises at least one portion made in an electrical conducting material and the support 20 comprises one or more inductive sensors. Other means for determining position could be considered like, for example, those defined above.

The design system 1 of the invention further comprises a conversion means to convert an item of position information of an object 10 placed on at least one portion 210 of said surface 21 of said support 20 into an item of position information of a refurbishment element in said kitchen. An example of conversion means is an IT conversion module. It can be integrated in the support 20 or be external to the latter.

The design system 1 of the invention further comprises a refurbishment determination means arranged for a determination 106 of a kitchen 40 refurbishment project 107 on the basis of position information of the refurbishment elements 50 in said kitchen 40 and on the basis of at least one technical constraint. Preferably, the kitchen 40 refurbishment project 107 comprises a plan indicating the position of the refurbishment elements 50 in the kitchen 40.

The design system 1 of the invention further comprises a means of output to provide information about the project for refurbishing said kitchen. The means of output can comprise a printer to directly print information about the refurbishment project. The means of output can comprise display means 22, to display, for example in real time, information about the refurbishment project. The means of output can comprise an internet connection, for example, to send a message comprising information about the refurbishment project.

According to an embodiment of the invention, the means for determining position and the conversion means form part of one same computer.

Different types of supports 20 can be used. Preferably, the support 20 is a touchscreen. In this case, the screen is preferably divided into one or more areas (or portions). One portion thus represents the work area 210 intended to receive the object(s) 10.

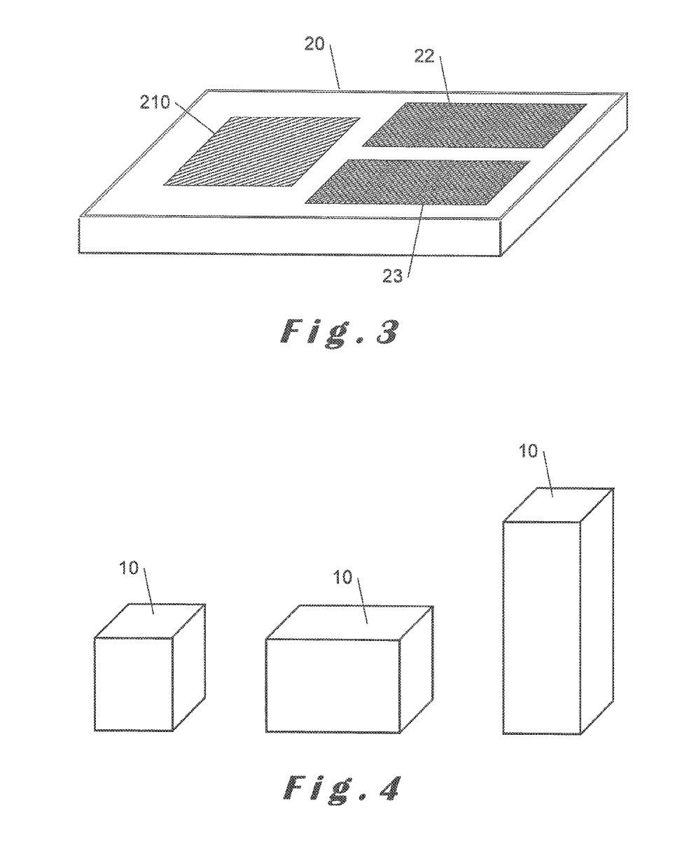

FIGS. 2 and 3 show another preferred embodiment of the support 20 where the latter comprises three different areas. One area is the work area 210 intended to receive the objects 10.

Another area represents the display means 22. When the support 20 is a touchscreen, this area represents a portion of said screen, for example. Thanks to these display means 22 or display area, it is possible to see the kitchen to be refurbished with different refurbishment elements corresponding to different objects 10 present on the work area 210. This visualisation can be done directly, which is very practical for a user of the design system 1 of the invention wishing to refurbish a kitchen. According to the result that they can see from the display means 22, the user can decide to replace an object 10 with another or move one or more of them. The design of the kitchen refurbishment is particularly effective thanks to this direct visualisation. The display means 22 can enable to see the kitchen to be refurbished and/or to refurbish it two- or three-dimensionally. When this is a two-dimensional view, the visualisations along different sections or different views are possible (top view, side view, for example).

In the example shown in FIG. 2, the surface 21 of the support 20 also comprises an interfacing portion 23. This interfacing portion 23 can fulfil several functions. It can be considered to be able to configure the kitchen to be refurbished. For example, setting geometric dimensions of an item to refurbish, adding or removing one or more door(s), window(s). This interfacing portion 23 can also enable a user to know the characteristics, particularly technical, of refurbishment elements represented by the objects 10, like for example: the available colours, the availability in stock, the weight, etc. The interfacing portion 23 can also recommend a specific refurbishment of the kitchen. According to certain preferred versions of the design system of the invention, the interfacing portion 23 enables to view and/or record a refurbishment project, print a list of refurbishment elements, place an order. In another possible embodiment, the design system 1 of the invention comprises an interfacing means 23 external to said support 20. For example, this can be an external computer screen with a keyboard and a mouse, or a touchscreen external to said support 20.

FIG. 4 shows three examples of objects 10. Other shapes are possible. Preferably, when an object 10 has the shape of a parallelepiped rectangle, it has a size of between (2×2×2) and (20×20×20) cm³. Different materials and colours can be used for the objects 10. Examples of materials which can be used for the objects 10 are: wood, plastic material (PVC, for example), a metal such as aluminium.

Preferably, the design system 1 of the invention comprises an identification module, the objects 10 and the latter being configured such that it is able to identify an object 10 present on the work area 210. Different technologies can be used to identify an object 10 present on the work area 210. According to an example illustrated in FIG. 5, each object 10 preferably comprises, on an external surface (for example, the wooden face thereof), a visual code 11 able to be scanned, for example, by reading means forming part of the support 20. The design system 1 of the invention is thus able to distinguish and identify the different objects 10 present on the work area 210 and to provide an item of kitchen refurbishment information comprising different refurbishment elements corresponding to the different objects 10 identified on the work area 210.

According to an embodiment of the invention, the technical characteristics are connected to the refurbishment elements 50. Such technical characteristics can, for example, be the dimensions of the refurbishment element, the possible colours thereof, the possible interior refurbishments thereof, the connections thereof for connecting water, gas and/or electricity. These technical characteristics are preferably included during the determination 106 of the refurbishment project (FIG. 9).

Preferably, the design system 1 of the invention comprises a memory to record a kitchen refurbishment project from an item of information generated by the refurbishment determination means. Such a memory can be integrated in the support 20 or be external.

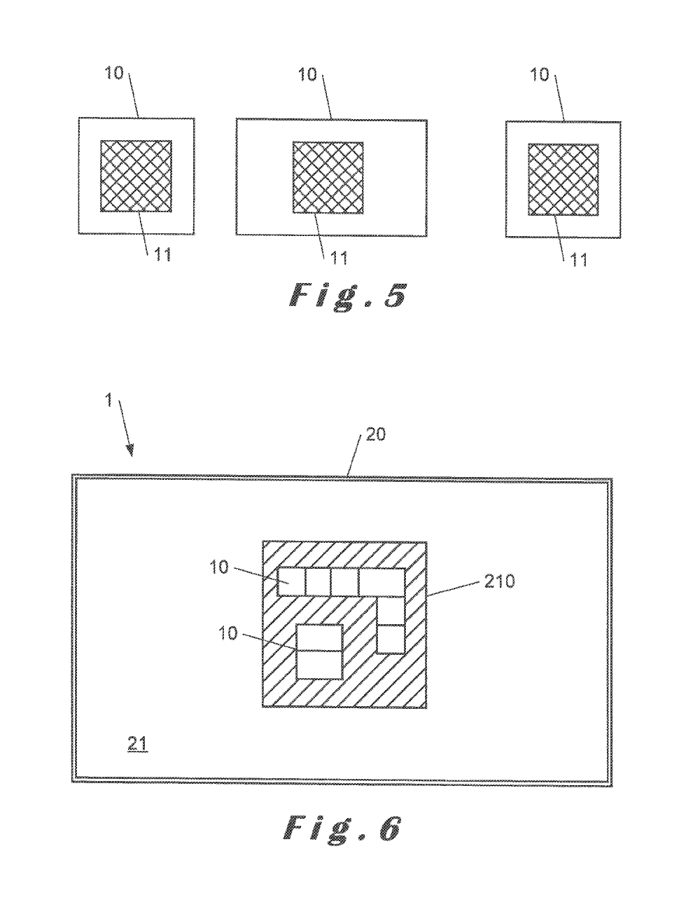

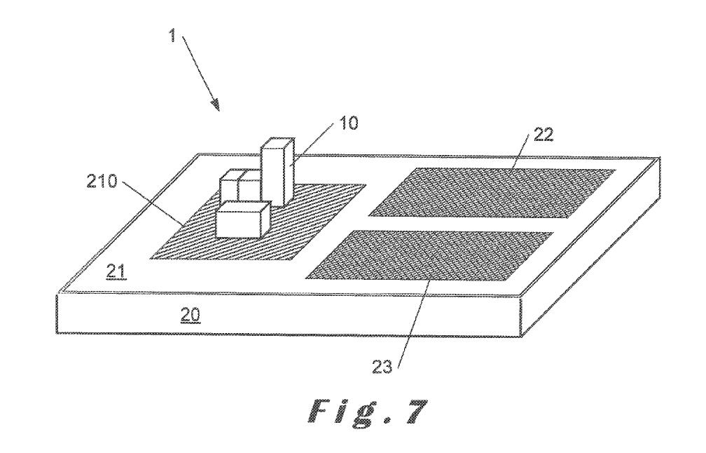

FIGS. 6 and 7 show two examples of a design system 1 of the invention where different objects 10 are placed on the work area 210 of the support 20. For the preferred embodiment in FIG. 7, the surface 21 of the support 20 comprises a display screen 22 and an interfacing screen 23 in addition to the work area 210.

Preferably, the method of the invention further comprises a step of identifying an object 10 placed on the portion 210 of the surface 21 of the support 20. For this, different technologies can be used as this has been defined previously.

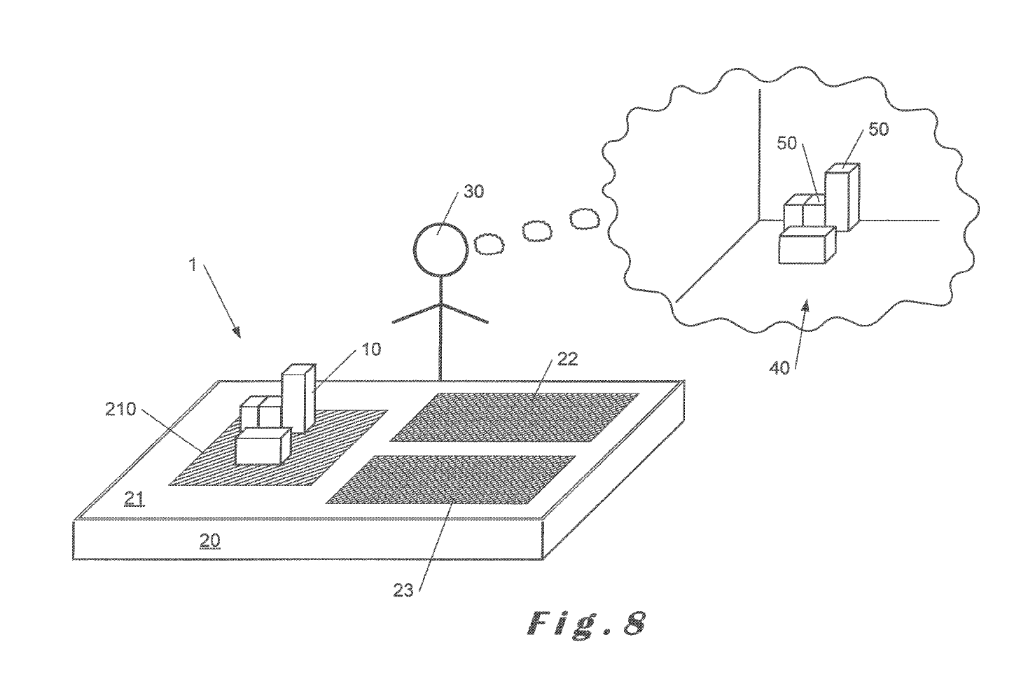

FIG. 8 illustrates a user 30 in the process of using a system 1 according to an embodiment of the invention. At the start, they enter into the system 1, using the interfacing screen 23, the dimensions and positions of the walls, windows, doors, bay windows and other obstacles of their kitchen 40. Preferably, a diagram of the walls, windows, bay windows and other obstacles as a top view is displayed on the work area 210 of the support 20 and a three-dimensional view of the walls, windows and doors as a top view is displayed on the display screen 22. When the user 30 conceptualises a kitchen 40 refurbishment comprising the refurbishment elements 50, he places the objects 10 corresponding to these refurbishment elements 50 on the work area 210 of the support 20. The objects 10 are identified and their position is determined. Icons corresponding to the identification of the objects 10 can appear on the work area 210 next to the objects. These icons correspond to information requests to the user 30, such that they can modify the technical characteristics of the refurbishment elements 50 represented by these objects 10. These technical characteristics are then included by the system to determine a refurbishment project 107 and the information 109 about the refurbishment project (FIG. 9). Furthermore, the display screen 22 can display three-dimensional illustrations of the refurbishment elements 50 at their position in the kitchen 40. The user 30 can, by moving the objects and by seeing the visualisation of the kitchen 40 on the display screen 22, refurbish their kitchen 40 by changing their mind numerous times.

Preferably, if the user 30 positions an object 10 outside of the kitchen 40 (in other words, outside of the surface defined by the walls displayed), an error message is displayed. Likewise, if an object 10 is positioned above a wall or another obstacle.

According to a second aspect, the invention relates to a method for aiding the design of a kitchen refurbishment. An embodiment of the method is illustrated in FIG. 9. When the objects 10 are positioned on the work area 210, a determination 101 of their position is made, which provides an item of position information 102 indicating the position of each object 10 on the surface 21. A conversion 103 converts the position information 102 of the objects 10 into an item of position information of the refurbishment elements 50 in the kitchen 40. This conversion 103 preferably comprises a change in scale to go from the scale of the objects 10 to the scale of the refurbishment elements 50. A determination 106 of a refurbishment project uses the position information of the refurbishment elements 50 in the kitchen 40 and the technical constraints 105 to determine a kitchen 40 refurbishment project 107.

An output 108 provides information 109 about the refurbishment project 107, preferably in a form that can be read by an IT device or by a human being. This output 108 can, for example, comprise the display on the display screen 22 of three-dimensional illustrations of the refurbishment elements 50 at their position in the kitchen 40. The steps 101 to 109 are preferably carried out each time an object 10 is added on the surface 21, raised from the surface 21 or moved on the surface 21. Furthermore, when the user so wishes, the output 108 releases a plan of the refurbishment project 107 comprising information 109 about the refurbishment project 107 and/or a list comprising information 109 about the refurbishment project 107.

According to an embodiment, the method for aiding the design of a kitchen refurbishment according to the invention comprises, after the arrangement of the objects 10 and before the determination 106 of the kitchen refurbishment project 107, a step of corresponding the objects 10 arranged with the refurbishment elements 50, and a step for determining, on the basis of the refurbishment elements 50 this identified, the technical characteristics specific to said refurbishment elements 50.

According to an embodiment, the method for aiding the design of a kitchen refurbishment according to the invention further comprises one or more step(s) of configuring the refurbishment elements. This enables to determine the model of the refurbishment elements 50, the type of internal storage, the type of door, finishes, colours, etc. A configuration step can comprise information requests to the user 30, such that they can modify the technical characteristics of the refurbishment elements 50, as defined in reference to FIG. 8.

For example, if the user 30 places an object representing a dishwasher, the system 1 asks them to choose the dishwasher model. Following this, the system 1 determines the technical characteristics specific to this dishwasher model and includes them for the determination 106 of the refurbishment project 107. Consequently, the position of the connection to a water inlet, the position of the water outlet and the position of the electricity inlet are automatically integrated into a plan provided by the system 1.

Preferably, the determination 106 of the refurbishment project comprises the determination of at least one line of refurbishment elements 42 (visible in FIG. 10). For example, if two refurbishment elements 50 have distant side faces of less than a certain threshold, they are preferably considered as forming part of one same line 42 and are automatically aligned.

According to an embodiment, the determination 106 of the refurbishment project uses a decision-making diagram to include the position information 104 of the refurbishment elements 50 and the technical constraint(s) 105. Preferably, the decision-making diagram processes the refurbishment elements 50 one by one by applying an automatic procedure to them.

According to an embodiment, the determination 106 of the refurbishment project determines the shape of the kitchen 40 refurbishment, in other words, if the kitchen 40 is in a single line, L-shaped or U-shaped. This determination of the shape of the refurbishment preferably uses a determination of the lines of refurbishment elements 42. For example, if the kitchen 40 refurbishment only comprises one single line 42 of refurbishment elements and does not comprise angled furniture, the shape thereof is preferably as a single line and a first decision-making diagram is used by determining 106 the refurbishment project.

Preferably, if there is an angled item of furniture among the refurbishment elements 50, this is processed first by a decision-making diagram used by determining 106 the refurbishment project. This enables the angled furniture to be correctly aligned on the two walls, the other refurbishment elements 50 being positioned in relation to this angled item of furniture in the decision-making diagram.

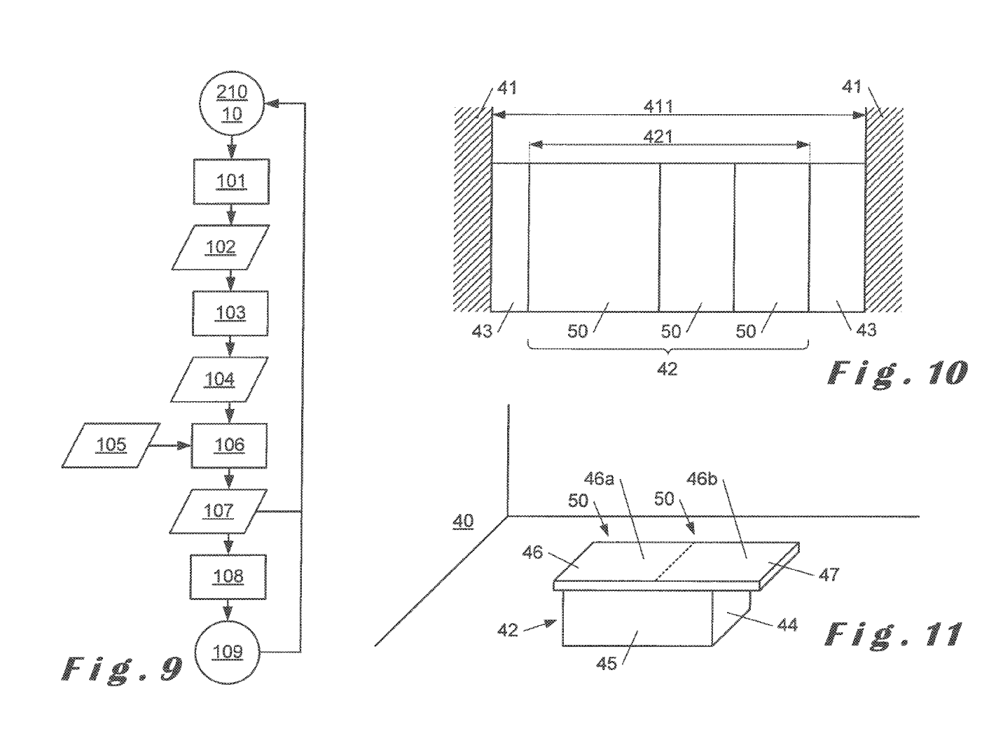

Preferably, the determination 106 of the refurbishment project comprises the verification of one or more of the following technical constraints 105: a worktop must preferably cover the refurbishment elements forming less than a certain height, the distance between the rear face of a refurbishment element 50 and a wall must preferably be in a determined interval, the distance between the side face of a refurbishment element 50 and a wall must preferably be in a determined interval, the distance between two refurbishment elements 50 must preferably be in a determined interval, the extension of a cantilevered worktop 46 (FIG. 11) must not preferably exceed a determined threshold, a water, gas or electricity inlet or a water outlet must preferably be connectable to the corresponding connection in the walls, the ground or the ceiling of the kitchen. When the verified technical constraint 105 is not satisfied, the system 1 either automatically corrects the refurbishment project 107, or displays an error message for the user, such that they modify the position of the objects 10 or enter into the system 1, data relating to the refurbishment project 107.

For example, if the objects 10 corresponding to the refurbishment elements 50 of one same line 42 are not against each other, said refurbishment elements 50 will automatically be positioned against each other in the refurbishment project 107 if the distance between their side faces is beyond certain threshold.

For example, if the objects 10 corresponding to the refurbishment elements 50 of one same line 42 are not aligned, said refurbishment elements 50 will automatically be aligned in the refurbishment project 107.

For example, if the distance between the rear face of a refurbishment element 50 and a wall is beyond a first value, said refurbishment element is offset from the wall in the refurbishment project 107. For example, if the distance between the rear face of a refurbishment element 50 and a wall is beyond a second value, a backrest 45 (FIG. 11) is provided behind said refurbishment element in the refurbishment project 107.

For example, for each object 10, the determination 101 of position determines the orientation of the object 10 and the conversion 103 determines the orientation of the corresponding refurbishment element 50 in the kitchen 40. The determination 106 of the refurbishment project determines the angle between the refurbishment element 50 and a wall of the kitchen 40. If this angle is in a determined first interval, the system 1 displays an error message for the user, such that it best aligns the object 10. If this angle is in a determined second interval, the determination 106 of the refurbishment project modifies this angle such that the refurbishment element 50 is aligned with the wall.

According to an embodiment, the determination 106 of the refurbishment project determines a “state” for each one of the front, rear and side faces of a refurbishment element 50. For example, the state 1 of a face can be that the face is stuck, in particular against another refurbishment element 50 or a wall. For example, the state 2 of a face can be that the face is removed, in particular from another refurbishment element 50 or a wall, but that it is invisible for someone in the kitchen 40. For example, the state 3 of a face can be that the face is removed, in particular from another refurbishment element 50 or a wall, and that it is visible for someone in the kitchen 40.

Preferably, the determination 106 of the refurbishment project verifies one or more technical constraint(s) according to the states of the faces of the refurbishment elements and potentially according to the type of furniture (floor unit, cabinet, right-angled unit, left-angled unit, dishwasher, etc.).

According to an embodiment, the determination 106 of the refurbishment project determines one or more additional refurbishment component(s) which will be integrated in the refurbishment project 107 and of which the technical characteristics are then returned in the information 109 about the refurbishment project 107. The determination of an additional refurbishment component can be combined with the technical constraint verification.

For example, as illustrated in FIG. 10, the refurbishment elements 50 can form a line 42 situated between two walls 41 of the kitchen 40. According to an embodiment of the invention, the system 1 determines a length 421 of the line 42 and a distance 411 between the two walls 41. If the length 421 of the line 42 is smaller than the distance 411 between the two walls 41 decreased by twice a minimum filler 43 size, the system 1 displays an error message. Otherwise, if the difference between the distance 411 between the two walls 41 and the length 421 of the line 42 is smaller than twice a maximum filler 43 size, the fillers 43 are automatically positioned between the ends of the line 42 and the walls 41 in the refurbishment project 107. The minimum size and the maximum size of the fillers 43 are memorised beforehand in the system 1.

FIG. 11 illustrates a situation where two refurbishment elements 50 form a kitchen island in line 42. The rear faces of these two refurbishment elements 50 are distant from any wall. A backrest 45 is thus automatically added on the rear faces of these two refurbishment elements 50 in the refurbishment project 107. In addition, two side faces of refurbishment elements 50, situated at the ends of the line 42, are distant from any wall. The side panels 44 are thus automatically added on these side faces in the refurbishment project 107.

Furthermore, preferably, a worktop 46 is automatically added in the refurbishment project 107. Preferably, the system 1 displays an icon on the right of the line 42 enabling the user to extend the worktop 46 by a cantilevered extension 47. The extension 47 enabled by the system 1 will be limited by, on the one hand, the maximum size of panels 46a, 46b forming the worktop 46 and, on the other hand, because said extension 47 must be able to support a certain weight without collapsing. According to an embodiment of the invention, the system 1 proposes the user 30 to position a side panel or poles under the extension 47 to support it.

According to an embodiment of the invention, the system 1 can, under certain circumstances, propose to the user 30, via a displayed message, to add an optional side panel on certain side faces of refurbishment elements 50. Preferably, this optional side panel mainly has an aesthetic function. For example, when a side face of a refurbishment element 50 is in a state 2, the system 1 can propose to the user 30 to position a side panel.

According to an embodiment of the invention, the backrest 45 is automatically added to the refurbishment project 107 when the rear face of a refurbishment element 50 is in a state 3.

According to an embodiment of the invention, when a refurbishment element 45 identified as an angled item of furniture is not situated in an angle in the refurbishment project 107, the system 1 displays an error message to the user 30.

Preferably, the method of the invention comprises a step of providing an item of refurbishment information of the kitchen to be refurbished from a result of the step of determining position and/or the step of identifying an object 10 placed on a portion of the surface 21 of the support 20. Preferably, the method of the invention comprises a step of recording a project for refurbishing a kitchen and/or modifying an existing project and/or printing a list of refurbishment elements.

Preferably, the method of the invention comprises a step of analysing a refurbishment project generated to verify if there are possible errors. Preferably, the method of the invention comprises a step of detecting possible errors in a refurbishment project. Preferably, the method of the invention comprises a step of recommending a user to satisfy aesthetic and/or technical criteria.

Preferably, the design system and the method of the invention give the possibility to a user to see the kitchen refurbishment through holographic glasses, virtual reality glasses or augmented reality glasses. Such glasses thus form an integral part of the design system of the invention. According to this preferred embodiment, the user can move virtually inside the refurbished kitchen from the objects arranged on the work area 210 of the surface 21 of the support 20. Preferably, this preferred embodiment is used when the design system 1 of the invention comprises a memory to record a refurbishment project. According to a preferred embodiment, the design system 1 of the invention comprises an IT program to suggest the next refurbishment elements for the kitchen. This can be done, for example, through the intermediary of an interfacing means 23 such as defined previously.

The design system and the method of the invention can be used for any types of refurbishment of an interior or exterior space, like for example: a kitchen, a bathroom, a living room.

According to a possible embodiment of the invention, this relates to a design system 1 for aiding the design of a refurbishment of a space and comprising:
a plurality of objects 10 to represent, under a reduced size, a plurality of refurbishment element of said space;
a support 20 comprising a surface 21 of which at least one portion is able to support one or more objects 10 of said plurality of objects 10;
a means for determining position,
   said objects 10 and said means for determining position being configured such that the latter is able to determine a position of an object 10 placed on at least one portion 210 of said surface 21 of said support 20;
a conversion means to convert an item of position information of an object 10 placed on at least one portion 210 of said surface 21 of said support 20 into an item of position information of a refurbishment element in said space.

The present invention has been defined in relation to specific embodiments, which have a purely illustrative value and must not be considered as limitative. Generally, the present invention is not limited to the examples illustrated and/or defined above. The use of the verbs “contain”, “include”, “comprise” or any other alternative, as well as their conjugations, cannot, in any way, exclude the presence of elements other than those mentioned. The use of the indefinite article “a”, “an” or of the definite article “the” to introduce an element does not exclude the presence of a plurality of these elements. The reference numbers in the claims do not limit their scope.

To summarise, the invention can also be defined as follows. Design system 1 comprising: a plurality of objects 10 to represent, under a reduced size, a plurality of refurbishment elements of a space; a support 20 comprising a surface 21 of which at least one portion is able to support one or more objects of said plurality of objects 10; a means for determining position, said objects 10 and said means for determining position being configured such that the latter is able to determine a position of an object 10 placed on at least one portion 210 of said surface 21 of said support 20; a conversion means to convert an item of position information of an object 10 placed on at least one portion 210 of said surface 21 of said support 20 into an item of position information of a refurbishment element in said space. The design system 1 of the invention can be used to provide aesthetic and/or technical recommendations to a user. The system enables the automatic inclusion of technical constraints in a kitchen refurbishment project.

1. A design system for aiding the design of a kitchen (40) refurbishment and comprising:
a plurality of objects to represent, under a reduced size, a plurality of refurbishment elements of said kitchen, said objects all being of one and the same reduced scale in relation to the refurbishment elements;
a support comprising a surface of which at least one portion is able to support said objects;
a means for determining position,
said objects and said means for determining position being configured such that the latter is able to determine a position for each one of the objects placed on said portion;
a conversion means to convert an item of position information of the objects placed on said portion into an item of position information in said kitchen of the refurbishment elements represented by said objects;
a refurbishment determination means to determine a project for refurbishing said kitchen on the basis of position information of the refurbishment elements in said kitchen obtained by said conversion means and on the basis of at least one technical constraint of a kitchen refurbishment; and
a means of output to provide information about the project for refurbishing said kitchen determined by said refurbishment determination means.

2. The design system according to claim 1, further comprising an identification module, of said objects and said identification module being configured such that the latter is able to identify the objects present on said portion and to correspond each one of them with a refurbishment element, the design system being able to determine, on the basis of said correspondence, the technical characteristics specific to said refurbishment element and to provide them to said refurbishment determination means such that they are included in the kitchen refurbishment project.

3. The design system according to claim 2, wherein at least one refurbishment element has a technical characteristic indicating a position of a connection for a water inlet and/or an electricity inlet and in that the information about the kitchen refurbishment project comprises an indication of position of a connection for a water inlet and/or an electricity inlet.

4. The design system according to claim 1, wherein said at least one technical constraint is a technical constraint determined from a difference between a length connected to one or more refurbishment elements and a distance between two walls of the kitchen.

5. The design system according to claim 1, wherein said refurbishment determination means is able to involve at least one additional refurbishment component in said project for refurbishing said kitchen on the basis of said at least one technical constraint, the information about the project for refurbishing said kitchen comprising an item of information about said at least one additional refurbishment component.

6. The design system according to claim 5, wherein the at least one additional refurbishment component comprises one or more refurbishment component(s) among the following: a filler to fill a space between the refurbishment elements and a wall of the kitchen, a side panel to cover an end of a line of refurbishment elements, a backrest intended to cover the rear faces of refurbishment elements, a worktop.

7. The design system according to claim 1, further comprising an interfacing means for aiding the design of the kitchen refurbishment, said interfacing means being integrated in said support.

8. The design system according to claim 1, further comprising a memory to record the project for refurbishing said kitchen.

9. The design system according to claim 1, wherein the refurbishment determination means are able to modify the position and/or the orientation of the refurbishment elements provided by the position information coming from the conversion means in order to satisfy at least one technical constraint.

10. The design system according to claim 1, wherein it is able to determine an angle between a refurbishment element represented by an object and a wall of the kitchen and to display a message if this angle is in a determined first interval.

11. The design system according to claim 1, wherein the means of output comprise a printer.

12. The design system according to claim 1, wherein the means of output comprise display means.

13. The design system according to claim 1, wherein the means of output comprise an internet connection.

14. The design system according to claim 1, wherein the means for determining position and the conversion means form part of one same computer.

15. A method for aiding the design of a kitchen refurbishment and comprising the following steps:
providing a plurality of objects representing, under a reduced size, a plurality of elements for refurbishing said kitchen, said objects all being of one and the same reduced scale in relation to the refurbishment elements;
providing a support (20) comprising a surface of which at least one portion is able to support said objects;
arranging the objects said plurality of objects on said portion;
determining a position for each one of the objects placed on said portion;
converting an item of position information of the objects placed on said portion into an item of position information in said kitchen of the refurbishment elements represented by said objects;
determining a project for refurbishing said kitchen on the basis of position information of the refurbishment elements in said kitchen obtained in the preceding step and on the basis of at least one technical constraint of a kitchen refurbishment; and
providing information about the project for refurbishing said kitchen determined in the preceding step.

16. The method according to claim 15, further comprising, after the step of arranging the objects and before the step of determining a kitchen refurbishment project, a step of identifying the objects present on said portion and corresponding each one of them with a refurbishment element and a step of determining, on the basis of said correspondence, the technical characteristics specific to said refurbishment element, said technical characteristics specific to said refurbishment element being used during the determination of the kitchen refurbishment project.

17. The method according to claim 15, wherein the step of determining a project for refurbishing said kitchen comprises a verification of at least one technical constraint and, in the event where said at least one verified technical constraint is not adhered to, a display of a message or an automatic correction of the refurbishment project such that this adheres to at least one verified technical constraint.

18. The method according to claim 15, further comprising a step of displaying an information request to a user, a step of receiving an item of user information and a consideration of the user information during the step of determining a project for refurbishing said kitchen.

19. The method according to claim 15, further comprising a display, on the portion of said surface of said support provided such that the objects are arranged there, of a diagram representing the walls of the kitchen.

20. The method according to claim 19, wherein a positioning of an object outside of a surface between the walls of the kitchen generates a display of a message.

21. The method according to claim 15, wherein the step of determining a project for refurbishing said kitchen comprises involving at least one additional refurbishment component in said project for refurbishing said kitchen, and in that the step of providing the information about the project for refurbishing said kitchen comprises providing an item of information about said at least one additional refurbishment component.

22. The method according to claim 15, wherein the step of determining a project for refurbishing said kitchen comprises determining a distance between two refurbishment elements, and if this distance is below a certain threshold, and aligning said two refurbishment elements with each other.

23. The method according to claim 15, wherein the determination of the refurbishment project uses a decision-making diagram to include position information the refurbishment elements and the technical constraint(s).

24. The method according to claim 15, wherein the kitchen refurbishment project comprises a plan indicating the position in the kitchen of the refurbishment elements, and, if the project comprises them, the position in the kitchen of the additional refurbishment components.

25. The method according to claim 15, wherein the kitchen refurbishment project comprises a list of refurbishment elements and, if the project comprises them, the additional refurbishment components.

26. The method according to claim 15, wherein said information about the refurbishment project comprises a plan indicating the position in the kitchen of the refurbishment elements and, if the project comprises them, the position in the kitchen of the additional refurbishment components.

27. The method according to claim 15, wherein said information about the refurbishment project comprises a list of refurbishment elements and, if the project comprises them, the additional refurbishment components.

28. The method according to claim 27, wherein said list comprises an item of information about a price of at least one refurbishment element.

29. The method according to claim 15, wherein said information about the refurbishment project comprises a three-dimensional image of the kitchen comprising the refurbishment elements and, if the project comprises them, the additional refurbishment components.
